(19) United States
(12) Patent Application Publication
(10) Pub. No.: US 2019/0055376 A1
(43) Pub. Date: Feb. 21, 2019

(54) PLASTICIZER COMPOSITION CONTAINING POLYMERIC DICARBOXYLIC ACID ESTERS AND PHTHALIC ACID DIALKYL ESTERS

(71) Applicant: BASF SE, Ludwigshafen am Rhein (DE)

(72) Inventors: Matthias PFEIFFER, Böhl-lggelheim (DE); Boris BREITSCHEIDEL, Waldsee (DE); Axel GRIMM, Edenkoben (DE); Herbert MORGENSTERN, Ellerstadt (DE)

(21) Appl. No.: 15/764,051

(22) PCT Filed: Sep. 29, 2016
(86) PCT No.: PCT/EP2016/073233

§ 371 Date: Mar. 28, 2018

(30) Foreign Application Priority Data
Sep. 30, 2015 (EP) 15187711.5

(51) Int. Cl. C08K 5/12; C08G 63/16; C08L 27/06; C08J 5/18

(52) U.S. Cl. CPC C08K 5/12; C08G 63/16; C08J 2467/02; C08J 5/18; C08J 2327/06; C08L 27/06

(57) ABSTRACT

The present invention relates to a plasticizer composition containing at least one polymeric dicarboxylic acid ester and at least one phthalic acid dialkyl ester, to molding compounds containing a thermoplastic polymer or an elastomer and such a plasticizer composition, and to the use of said plasticizer compositions and molding compounds.

### BACKGROUND OF THE INVENTION

The present invention relates to a plasticizer composition which comprises at least one polymeric dicarboxylic acid ester and at least one phthalic acid dialkyl ester, to molding materials which comprise a thermoplastic polymer or an elastomer and such a plasticizer composition, and to the use of these plasticizer compositions and molding materials.

### PRIOR ART

To achieve desired processing and/or application properties, so-called plasticizers are added to a large number of plastics in order to make them softer, more flexible and/or more extensible. In general, the use of plasticizers serves to shift the thermoplastic range of plastics to lower temperatures in order to retain the desired elastic properties in the range of low processing and use temperatures.

Polyvinyl chloride (PVC) is one of the most manufactured plastics in terms of amount. On account of its diverse applicability, it is nowadays found in a large number of everyday products. PVC is therefore attributed very great economic importance. PVC is originally a plastic that is hard and brittle up to approx. 80° C. which is used as rigid PVC (PVC-U) by adding thermostabilizers and other aggregates. Only the addition of suitable plasticizers gives flexible PVC (PVC-P) which can be used for many application purposes for which rigid PVC is unsuitable.

Further important thermoplastic polymers in which plasticizers are usually used are e.g. polyvinylbutyral (PVB), homopolymers and copolymers of styrene, polyacrylates, polysulfides or thermoplastic polyurethanes (PU).

Whether a substance is suitable for use as plasticizer for a certain polymer largely depends on the properties of the polymer to be plasticized. As a rule, desired plasticizers are those which have a high compatibility with the polymer to be plasticized, impart good thermoplastic properties to it and have only a slight tendency towards evaporation and/or exudation (high permanency).

A large number of different compounds is available on the market for plasticizing PVC and further plastics. On account of their good compatibility with the PVC and their advantageous application properties, phthalic acid diesters with alcohols of varying chemical structure have often been used as plasticizers in the past, such as e.g. diethylhexyl phthalate (DEHP), diisononyl phthalate (DINP) and diisodecyl phthalate (DIDP).

Besides phthalic acid esters, various further plasticizers having different properties are known in the prior art for various plastics and specifically for PVC.

Various alternative plasticizers having different properties are known in the prior art for various plastics and specifically for PVC.

A plasticizer class known from the prior art is based on cyclohexanepolycarboxylic acids, as described in WO 99/32427. In contrast to their nonhydrogenated aromatic analogs, these compounds are toxicologically acceptable and can even be used in sensitive application areas.

WO 00/78704 describes selected dialkylcyclohexane-1,3- and 1,4-dicarboxylic acid esters for use as plasticizers in synthetic materials.

A further plasticizer class known from the prior art is based on terephthalic acid, as described for example in WO 2009/095126.

Furthermore, esters of adipic acid are also used as plasticizers, especially also for polyvinyl chloride. The most important representatives are adipic acid esters with C₈-, C₉- and C₁₀-alcohols, e.g. di(2-ethylhexyl) adipate, diisononyl adipates and diisodecyl adipates, which are used primarily in films, profiles, synthetic leather, cables and leads based on flexible PVC if the products are to be used at low temperatures. DE 2009505 describes, for example, bisisononyl esters of adipic acid which are obtained by esterification of adipic acids with isononanols which have been prepared from 2-ethylhexene according to the oxo synthesis by reaction with carbon monoxide and hydrogen and optionally subsequent hydrogenation. The described bisisononyl adipic acid esters are said to be suitable as plasticizers for polyvinyl chloride and are distinguished by low volatility, low viscosity and good low-temperature strength of the polyvinyl chloride materials plasticized therewith. U.S. Pat. No. 4,623,748 describes dialkyl adipates which are prepared by reacting propylene or butylene oligomers from the dimersol process in the presence of supported tantalum(V) halides/oxides as catalysts, reaction of the resulting C₈-, C₉- or C₁₂-Olefins to C₉-, C₁₀- or C₁₃-alcohols and esterification of these alcohols with adipic acid. These dialkyl adipates are said to be notable for high flash points and suitable for use as lubricants. EP 1171413 describes mixtures of diesters of adipic acid with isomeric nonanols which are said to be suitable as plasticizers for polyvinyl chloride and are distinguished in particular by very good low-temperature elastic properties of the polyvinyl chloride materials plasticized therewith.

Besides monomeric plasticizers, various polyesters are likewise used as plasticizers. Polyester plasticizers are generally produced by esterifying polyhydric alcohols, for example 1,2-ethanediol, 1,2-propanediol, 1,3-propanediol, 1,3-butanediol, 1,4-butanediol, 1,5-pentanediol or 1,6-hexanediol, with a polycarboxylic acid, such as succinic acid, glutaric acid, adipic acid, pimellic acid, suberic acid, sebacic acid, azelaic acid or phthalic acid. Optionally, terminal alcohol groups (in the case of syntheses with alcohol excess) can be terminated with monocarboxylic acids, for example acetic acid, or terminal acid groups (in the case of syntheses with acid excess) can be terminated with monohydric alcohols, such as 2-ethylhexanol, isononanol, 2-propylheptanol or isodecanol. Polyester plasticizers are primarily used in the production of films, coatings, profiles, floor coverings and cables based on flexible PVC if increased requirements are placed on the extraction resistance, in particular towards benzine, oils and fats, the UV stability and the volatility of the plasticizer.

U.S. Pat. No. 5,281,647 describes a process for producing polyester plasticizers in which dicarboxylic acids, such as sebacic acid, glutaric acid, azelaic acid and/or adipic acid are reacted with severely sterically hindered diols and small amounts of linear diols to give polyesters and then the acidic end groups of the polyesters are esterified with a further alcohol, and the use thereof for plasticizing rubber and PVC. Specifically, the production of a polyester plasticizer based on adipic acid, trimethylpentanediol and propylene glycol is described, with the terminal acid groups being esterified with 2-ethylhexanol. These polyesters are said to be suitable as plasticizers for PVC and rubber and are characterized by high extraction resistance to oils and soap solution.

RO 104737 describes polyester plasticizers based on adipic acid and propylene glycol, the terminal acid groups of which are esterified with 2-ethylhexanol. The polyesters are said to be suitable as plasticizers for PVC and are distinguished in particular by good storage stability.

EP 1113034 describes polyester plasticizers obtainable by reacting aliphatic dicarboxylic acids, neopentyl alcohol, at least one further diol and isomeric nonanols, a process for their production and their use as plasticizers. The polyesters are said to be distinguished in particular by a low migration tendency, in particular towards acrylonitrile-butadiene-styrene copolymers, polystyrene and polymethyl methacrylate.

To establish the desired plasticizer properties, it is also known to use mixtures of plasticizers, e.g. at least one plasticizer which has good thermoplastic properties, but gels less well, in combination with at least one plasticizer which has good gelling properties.

WO 03/029339 discloses PVC compositions comprising cyclohexanepolycarboxylic acid esters, and mixtures of cyclohexanepolycarboxylic acid esters with other plasticizers. Suitable other plasticizers are nonpolymeric ester plasticizers, such as terephthalic acid esters, phthalic acid esters, isophthalic acid esters and adipic acid esters. Furthermore, PVC compositions are disclosed which comprise mixtures of cyclohexanepolycarboxylic acid esters with various rapid-gelling plasticizers. Suitable rapid-gelling plasticizers mentioned are, in particular, various benzoates, aromatic sulfonic acid esters, citrates, and phosphates. Polyester plasticizers are mentioned only in the course of a quite general listing without being concreted in any way in the patent specification.

A significant disadvantage of most of the plasticizers or plasticizer compositions described above, however, is that they do not have sufficiently good compatibility with plastics, in particular with PVC, i.e. they exude to a considerable degree during use and therefore lead to partial loss of the elastic properties of the plasticized plastics produced using these plasticizers. This is true especially for the polyester plasticizers, the use of which is indispensible for many applications for which increased requirements are placed on the extraction resistance, primarily towards benzine, oils and fats, the UV stability and the volatility of the plasticizer.

The object of the present invention is to provide a plasticizer composition comprising at least one polyester plasticizer for thermoplastic polymers and elastomers which has high compatibility with the polymer to be plasticized and, as a result, has only a slight tendency, if any, towards exudation during use, as a result of which the elastic properties of the plasticized plastics produced using these plasticizers are retained even over extended periods.

### SUMMARY OF THE INVENTION

This object is surprisingly achieved by a plasticizer composition comprising

a) one or more compounds of the general formula (I),

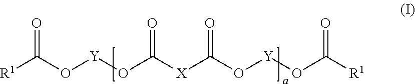

in which
X is in each case an unbranched or branched C₂-C₈-alkylene group or an unbranched or branched C₂-C₈-alkenylene group, comprising at least one double bond,
Y is in each case an unbranched or branched C₂-C₁₂-alkylene group or an unbranched or branched C₂-C₁₂-alkenylene group, comprising at least one double bond,
a is an integer from 1 to 100 and
R¹ independently of one another are selected from unbranched or branched C₁-C₁₂-alkyl radicals,
where the groups Y present in the compounds (I) can be identical or different from one another and
where if the compounds (I) comprise more than one group X, these may be identical or different from one another,
and

b) one or more compounds of the general formula (II),

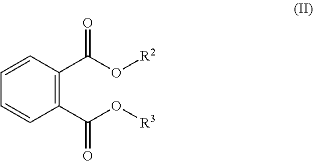

in which
R² and R³, independently of one another, are selected from branched and unbranched C₉-C₁₂-alkyl radicals.

The invention further provides molding materials which comprise at least one thermoplastic polymer or elastomer and a plasticizer composition as defined above and below.

The invention further provides the use of a plasticizer composition, as defined above and below, as plasticizer for thermoplastic polymers, in particular polyvinyl chloride (PVC), and elastomers.

The invention further provides the use of these molding materials for producing moldings and films.

### DESCRIPTION OF THE INVENTION

The plasticizer compositions according to the invention have at least one of the following advantages:
the plasticizer compositions according to the invention are distinguished by high compatibility with the polymers to be plasticized, in particular PVC.
The plasticizer compositions according to the invention have only a slight tendency, if any, towards exudation during the use of the end products. As a result, the elastic properties of the plasticized plastics produced using these plasticizer compositions are retained even over extended periods.
The plasticizer compositions according to the invention are advantageously suitable for achieving a large number of highly diverse and complex processing and application properties of plastics.

The plasticizer compositions according to the invention are suitable for use for producing moldings and films for sensitive application areas, such as medicinal products, food packagings, products for interiors, for example of apartments and vehicles, toys, childcare articles etc.

Easily accessible starting materials can be used for producing the compounds (I) present in the plasticizer compositions according to the invention.

The processes for producing the compounds (I) used according to the invention are simple and efficient. The compounds can therefore be provided without problem on an industrial scale.

In the context of the present invention, the expression “C₂-C₁₂-alkylene” refers to divalent hydrocarbon radicals having 2 to 12 carbon atoms. The divalent hydrocarbon radicals can be unbranched or branched. These include, for example, 1,2-ethylene, 1,2-propylene, 1,3-propylene, 1,3-butylene, 1,4-butylene, 2-methyl-1,3-propylene, 1,1-dimethyl-1,2-ethylene, 1,4-pentylene, 1,5-pentylene, 2-methyl-1,4-butylene, 2,2-dimethyl-1,3-propylene, 1,6-hexylene, 2-methyl-1,5-pentylene, 3-methyl-1,5-pentylene, 2,3-dimethyl-1,4-butylene, 1,7-heptylene, 2-methyl-1,6-hexylene, 3-methyl-1,6-hexylene, 2-ethyl-1,5-pentylene, 3-ethyl-1,5-pentylene, 2,3-dimethyl-1,5-pentylene, 2,4-dimethyl-1,5-pentylene, 1,8-octylene, 2-methyl-1,7-heptylene, 3-methyl-1,7-heptylene, 4-methyl-1,7-heptylene, 2-ethyl-1,6-hexylene, 3-ethyl-1,6-hexylene, 2,3-dimethyl-1,6-hexylene, 2,4-dimethyl-1,6-hexylene, 1,9-nonylene, 2-methyl-1,8-octylene, 3-methyl-1,8-octylene, 4-methyl-1,8-octylene, 2-ethyl-1,7-heptylene, 3-ethyl-1,7-heptylene, 1,10-decylene, 2-methyl-1,9-nonylene, 3-methyl-1,9-nonylene, 4-methyl-1,9-nonylene, 5-methyl-1,9-nonylene, 1,11-undecylene, 2-methyl-1,10-decylene, 3-methyl-1,10-decylene, 5-methyl-1,10-decylene, 1,12-dodecylene and the like.

The expression “C₂-C₁₂-alkylene” also includes in its definition the expressions “C₂-C₈-alkylene”, “C₂-C₆-alkylene”, “C₂-C₅-alkylene” and “C₃-C₅-alkylene”.

Preferably, “C₂-C₁₂-alkylene” is branched or unbranched C₂-C₈-alkylene groups, particularly preferably branched or unbranched C₂-C₅-alkylene groups, very particularly preferably branched or unbranched C₃-C₅-alkylene groups and in particular 1,2-propylene, 1,3-propylene, 1,4-butylene and 2,2-dimethyl-1,3-propylene.

Preferably, “C₂-C₈-alkylene” is branched or unbranched C₂-C₆-alkylene groups, particularly preferably branched or unbranched C₂-C₅-alkylene groups, in particular 1,3-propylene and 1,4-butylene.

In the context of the present invention, the expression “C₂-C₁₂-alkenylene” refers to divalent hydrocarbon radicals having 2 to 12 carbon atoms, which may be unbranched or branched, where the main chain has at least one double bond, for example 1, 2 or 3 double bonds. These include, for example, ethenylene, propenylene, 1-methylethenylene, 1-butenylene, 2-butenylene, 1-methylpropenylene, 2-methylpropenylene, 1-pentenylene, 2-pentenylene, 1-methyl-1-butenylene, 1-methyl-2-butenylene, 1-hexenylene, 2-hexenylene, 3-hexenylene, 1-methyl-1-pentenylene, 1-methyl-2-pentenylene, 1-methyl-3-pentenylene, 1,4-dimethyl-1-butenylene, 1,4-dimethyl-2-butenylene, 1-heptenylene, 2-heptenylene, 3-heptenylene, 1-octenylene, 2-octenylene, 3-octenylene, nonenylene, decenylene, undecenylene, dodecenylene and the like.

The double bonds in the alkenylene groups can be present, independently of one another, in the E and in the Z configuration or as a mixture of both configurations.

The expression “C₂-C₁₂-alkenylene” also includes in its definition the expressions “C₂-C₈-alkenylene”, “C₂-C₆-alkenylene” and “C₂-C₅-alkenylene”.

The C₂-C₁₂-alkenylene group is particularly preferably branched and unbranched C₂-C₈-alkenylene groups with a double bond, in particular branched and unbranched C₂-C₅-alkenylene groups with a double bond.

The C₂-C₈-alkenylene group is particularly preferably branched and unbranched C₂-C₈-alkenylene groups with a double bond, very particularly preferably branched and unbranched C₂-C₈-alkenylene groups with a double bond, in particular branched and unbranched C₂-C₅-alkenylene groups with a double bond.

In the context of the present invention, the expression “C₁-C₁₂-alkyl” refers to unbranched or branched alkyl groups having 1 to 12 carbon atoms. These include, for example, methyl, ethyl, n-propyl, isopropyl, n-butyl, isobutyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 1-methylpentyl, 2-methylpentyl, I-ethylbutyl, 2-ethylbutyl, n-heptyl, 1-methylhexyl, 2-methylhexyl, 1-ethylpentyl, 2-ethylpentyl, 1-propylbutyl, 1-ethyl-2-methylpropyl, n-octyl, isooctyl, 2-ethylhexyl, n-nonyl, isononyl, 2-propylhexyl, n-decyl, isodecyl, 2-propylheptyl, n-undecyl, isoundecyl, n-dodecyl, isododecyl and the like.

The expression “C₁-C₁₂-alkyl” also includes in its definition the expressions “C₁-C₆-alkyl” and “C₁-C₅-alkyl” and “C₄-C₁₂-alkyl” and “C₇-C₁₂-alkyl”.

Preferably “C₁-C₁₂-alkyl” is branched or unbranched C₁-C₅-alkyl groups, in particular branched or unbranched C₁-C₅-alkyl groups.

Preferably, “C₉-C₁₂-alkyl” is branched or unbranched C₉-C₁₂-alkyl groups, in particular branched or unbranched C₁₀-C₁₂-alkyl groups.

Unless stated otherwise, the measurement standards and standard parameters refer to the respective DIN, ISO, IUPAC standard or literature at the time of the application date.

Unless stated otherwise, the abbreviation “phr” stands for “parts by weight per 100 parts by weight of polymer”.

### Compounds of the General Formula (I)

Preferably, X in the general formula (I) is, independently of the others, an unbranched or branched C₂-C₅-alkylene group, particularly preferably an unbranched or branched C₂-C₆-alkylene group. In particular, X in the general formula (I) is, independently of the others, an unbranched C₂-C₅-alkylene group, specifically 1,3-propylene and 1,4-butylene.

If the compounds of the general formula (I) comprise more than one group X, these are preferably identical.

Preferably, Y in the general formula (I) is an unbranched or branched C₂-C₁₂-alkylene group, particularly preferably an unbranched or branched C₂-C₈-alkylene group. In particular, Y in the general formula (I) is a branched or unbranched C₂-C₅-alkylene group and specifically 1,2-propylene, 1,3-propylene, 1,2-butylene, 1,3-butylene, 1,4-butylene and 2,2-dimethyl-1,3-propylene.

If the compounds of the general formula (I) comprise more than one group Y, these are identical in a first preferred variant.

If the compounds of the general formula (I) comprise more than one group Y, these are different from one another in a second variant.

Preferably, a in the compounds of the general formula (I) is an integer from 1 to 70, particularly preferably an integer from 2 to 50, in particular an integer from 5 to 40.

Preferably, the radicals R¹ in the general formula (I) are, independently of one another, methyl, ethyl, n-propyl, isopropyl, n-butyl, isobutyl, n-pentyl, 2-pentyl, 2-methylbutyl, 3-methylbutyl, n-hexyl, 1-methylpentyl, 2-methylpentyl, 1-ethylbutyl, 2-ethylbutyl, n-heptyl, 1-methylhexyl, 2-methylhexyl, 1-ethylpentyl, 2-ethylpentyl, 1-propylbutyl, n-octyl, isooctyl, 2-ethylhexyl, n-nonyl, isononyl, 2-propylhexyl, n-decyl, isodecyl or 2-propylheptyl. Particularly preferably, the radicals R¹ in the general formula (I) are both methyl, both ethyl, both n-propyl, both isopropyl, both n-butyl, both isobutyl or both n-pentyl.

On account of their polymeric character, the compounds of the general formula (I) used in the plasticizer compositions according to the invention are not uniform compounds, but mixtures of different compounds. Firstly, the compounds (I) have different chain lengths, i.e. they are characterized by an average molar mass. Secondly, both radicals R¹, and the groups X and Y present in the repeat units can be different from one another. Furthermore, the radicals R¹ may be isomer mixtures, as defined below.

The polyester plasticizers of the general formula (I) present in the plasticizer compositions according to the invention generally have a weight-average molar mass in the range from 500 to 15 000 g/mol, preferably in the range from 2000 to 10 000 g/mol, particularly preferably in the range from 3000 to 8000 g/mol. The weight-average molar mass is generally determined by means of gel permeation chromatography (GPC) in tetrahydrofuran against polystyrene standard.

The gel permeation chromatography can be carried out in a standard commercial device, for example GPC-System Infinity 1100 from Agilent Technologies. Such measuring systems usually consist of pump, column heating, columns and a detector, for example DRI Agilent 1200.

The eluent used can be THF, which flows for example at a flow rate of 1 ml/min through a column combination of two columns heated to 35° C. The samples dissolved in a concentration of 2 mg/ml in THF are usually filtered before injection. The measurement values obtained are usually evaluated via a calibration curve. This can be obtained for example with narrowly distributed polystyrene standards, which is available for example from Polymer Laboratories with molecular weights of M=162 to M=50 400.

The polyester plasticizers of the general formula (I) present in the plasticizer compositions according to the invention generally have a density at 20° C. in accordance with DIN 51757 in the range from 1.000 to 1.300 g/cm³, preferably in the range from 1.100 to 1.200 g/cm³, particularly preferably in the range from 1.120 to 1.160 g/cm³.

The polyester plasticizers of the general formula (I) present in the plasticizer compositions according to the invention generally have a viscosity at 20° C. in accordance with DIN EN ISO 3219 in the range from 1000 to 20 000 mPa·s, preferably in the range from 1500 to 15 000 mPa·s, particularly preferably in the range from 2000 to 14 000 mPa·s. To determine the dynamic viscosity according to DIN EN ISO 3219, a sample of the polymer plasticizer in question is applied to the stator of the rotor-stator unit, consisting of a cone-plate measuring unit with a diameter of 25 mm, of a suitable rheometer. The dynamic viscosity is then determined by means of a rotational measurement at 20° C. and 128 rpm.

The polyester plasticizers of the general formula (I) present in the plasticizer compositions according to the invention generally have a refractive index nD20 according to DIN 51423 in the range from 1.450 to 1.485, preferably in the range from 1.460 and 1.480, particularly preferably in the range from 1.462 to 1.472.

Compounds of the general formula (II) Preferably, in the compounds of the general formula (II), the radicals R2 and R3, independently of one another, are n-nonyl, isononyl, n-decyl, isodecyl, 2-propylheptyl, 2-propyl-4-methylhexyl, 2-propyl-5-methylhexyl, 2-isopropylheptyl, 2-isopropyl-4-methylhexyl, 2-isopropyl-5-methylhexyl, 2-propyl-4,4-dimethylpentyl, n-undecyl, isoundecyl, n-dodecyl or isododecyl.

Particularly preferably, in the compounds of the general formula (II), the radicals R² and R³, independently of one another, are 2-propylheptyl, 2-propyl-4-methylhexyl, 2-propyl-5-methylhexyl, 2-isopropylheptyl, 2-isopropyl-4-methylhexyl, 2-isopropyl-5-methylhexyl or 2-propyl-4,4-dimethylpentyl, in particular 2-propylheptyl.

In a further preferred embodiment, the radicals R² and R³ are identical in the compounds of the general formula (I).

A specifically preferred compound of the general formula (II) is di(2-propylheptyl) phthalate.

### PARTICULAR EMBODIMENTS

In a preferred embodiment of the present invention, in the compounds of the general formulae (I) and (II),
X is an unbranched or branched C₂-C₅-alkylene group,
Y independently of the others is an unbranched or branched C₂-C₅-alkylene group,
a is an integer from 5 to 40,
R¹ independently of the others is a C₁-C₁₂-alkyl group and
R² and R³ are both a C₁₀-C₁₂-alkyl group.

In a particularly preferred embodiment of the present invention, in the compounds of the general formulae (I) and (II),
X is an unbranched C₂-C₅-alkylene group,
Y independently of the others is an unbranched or branched C₃-C₅-alkylene group,
a is an integer from 5 to 40,
R¹ are both methyl, both ethyl, both n-propyl, both isopropyl, both n-butyl, both isobutyl or both n-pentyl and
R² and R³ are both 2-propylheptyl, 2-propyl-4-methylhexyl, 2-propyl-5-methylhexyl, 2-isopropylheptyl, 2-isopropyl-4-methylhexyl, 2-isopropyl-5-methylhexyl or 2-propyl-4,4-dimethylpentyl.

By adapting the fractions of the compounds (I) and (II) in the plasticizer composition according to the invention, the plasticizer properties can be matched to the corresponding intended use. This can be effected through routine experiments. For use in specific application areas, it may optionally be helpful to add further plasticizers different from the compounds (I) and (II) to the plasticizer compositions according to the invention. For this reason, the plasticizer composition according to the invention can optionally comprise at least one further plasticizer different from the compounds (1) and (II).

The additional plasticizer different from the compounds (I) and (II) is selected from phthalic acid alkylarylalkyl ester, trimellitic acid trialkyl esters, benzoic acid alkyl esters, dibenzoic acid esters of glycols, hydroxybenzoic acid esters, monoesters of saturated monocarboxylic acids, monoesters of saturated hydroxymonocarboxylic acids, esters of unsaturated monocarboxylic acids, esters of saturated hydroxydicarboxylic acids, amides and esters of aromatic sulfonic acids, alkylsulfonic acid esters, glycerol esters, isosorbide esters, phosphoric acid esters, citric acid diesters, citric acid triesters, alkylpyrrolidone derivatives, 2,5-furandicarboxylic acid esters, 2,5-tetrahydrofurandicarboxylic acid esters, epoxidized vegetable oils, epoxidized fatty acid monoalkyl esters, 1,2-cyclohexanedicarboxylic acid dialkyl esters, 1,3-cyclohexanedicarboxylic acid dialkyl esters, 1,4-cyclohexanedicarboxylic acid dialkyl esters, polyesters of aliphatic and/or aromatic polycarboxylic acids with at least dihydric alcohols different from compounds (1), phthalic acid dialkyl esters different from compounds (II).

A suitable phthalic acid alkylaralkyl ester is, for example, benzyl butyl phthalate. Suitable trimellitic acid trialkyl esters preferably have, independently of one another, in each case 4 to 13 carbon atoms, in particular 7 to 11 carbon atoms, in the alkyl chains. Suitable benzoic acid alkyl esters preferably have, independently of one another, in each case 7 to 13 carbon atoms, in particular 9 to 13 carbon atoms, in the alkyl chains. Suitable benzoic acid alkyl esters are, for example, isononyl benzoate, isodecyl benzoate or 2-propyl heptyl benzoate. Suitable dibenzoic acid esters of glycols are diethylene glycol dibenzoate, dipropylene glycol dibenzoate, tripropylene glycol dibenzoate and dibutylene glycol dibenzoate. Suitable monoesters of saturated monocarboxylic acids and saturated hydroxymonocarboxylic acids are, for example, esters of acetic acid, butyric acid, valeric acid or lactic acid. Suitable esters of unsaturated monocarboxylic acids are, for example, esters of acrylic acid. Suitable esters of saturated hydroxydicarboxylic acids are, for example, esters of malic acid. Suitable alkylsulfonic acid esters preferably have an alkyl radical having 8 to 22 carbon atoms. These include, for example, phenyl or cresyl ester of pentadecylsulfonic acid. Suitable isosorbide esters are isosorbide diesters which are preferably esterified with C₈-C₁₃-carboxylic acids. Suitable phosphoric acid esters are tri-2-ethylhexyl phosphate, trioctyl phosphate, triphenyl phosphate, isodecyl diphenylphosphate, bis(2-ethylhexyl)phenyl phosphate and 2-ethylhexyl diphenylphosphate. In the citric acid diesters and citric acid triesters, the OH group can be present in free or carboxylated form, preferably acetylated. The alkyl radicals of the acetylated citric acid triesters preferably have, independently of one another, 4 to 8 carbon atoms, in particular 6 to 8 carbon atoms. Alkylpyrrolidone derivatives with alkyl radicals from 4 to 18 carbon atoms are suitable. Suitable 2,5-furandicarboxylic acid dialkyl esters have, independently of one another, in each case 7 to 13 carbon atoms, preferably 8 to 12 carbon atoms, in the alkyl chains. Suitable 2,5-tetrahydrofurandicarboxylic acid dialkyl esters have, independently of one another, in each case 4 to 13 carbon atoms, preferably 8 to 12 carbon atoms, in the alkyl chains. A suitable epoxidized vegetable oil is, for example, epoxidized soybean oil, e.g. available from Galata-Chemicals, Lampertheim, Germany. Epoxidized fatty acid monoalkyl esters, available for example under the trade name reFlex™ from PolyOne, USA, are also suitable. Suitable cyclohexane-1,4-dicarboxylic acid esters have, independently of one another, in each case 4 to 13 carbon atoms, in particular 8 to 11 carbon atoms, in the alkyl chains. A suitable cyclohexane-1,4-dicarboxylic acid ester is, for example, di(2-ethylhexyl) cyclohexane-1,4-dicarboxylate.

Suitable phthalic acid dialkyl esters different from compounds (II) independently of one another have 4 to 8 C atoms, preferably 6 to 8 C atoms, in the alkyl chains. Suitable 1,2-, 1,3- and 1,4-cyclohexanedicarboxylic acid dialkyl esters preferably independently of one another have alkyl radicals having 7 to 12 C atoms.

In all of the aforementioned cases, the alkyl radicals can in each case be linear or branched and in each case identical or different from one another. Reference is made to the general statements made at the start relating to suitable and preferred alkyl radicals.

The content of the at least one further plasticizer different from the compounds (I) and (II) in the plasticizer composition according to the invention is usually 0 to 50% by weight, preferably 0 to 40% by weight, particularly preferably 0 to 30% by weight and in particular 0 to 25% by weight, based on the total amount of the at least one further plasticizer and the compounds (I) and (II) in the plasticizer composition. If a further plasticizer is present, then preferably in a concentration of at least 0.01% by weight, preferably at least 0.1% by weight, based on the total amount of the at least one further plasticizer and the compounds (I) and (II) in the plasticizer composition.

In a preferred embodiment, the plasticizer composition according to the invention comprises no further plasticizer different from the compounds (I) and (II).

Preferably, the content of the compounds of the general formula (I) in the plasticizer composition according to the invention is 10 to 99% by weight, particularly preferably 30 to 95% by weight and in particular 50 to 90% by weight, based on the total amount of the compounds (I) and (II) in the plasticizer composition.

Preferably, the content of compounds of the general formula (II) in the plasticizer composition according to the invention is 1 to 90% by weight, particularly preferably 5 to 70% by weight and in particular 10 to 50% by weight, based on the total amount of the compounds (I) and (II) in the plasticizer composition.

In the plasticizer composition according to the invention, the weight ratio between compounds of the general formula (II) and compounds of the general formula (I) is preferably in the range from 1:100 to 10:1, particularly preferably in the range from 1:20 to 2:1 and in particular in the range from 1:10 to 1:1.

Molding Materials

The present invention further provides a molding material comprising at least one polymer and a plasticizer composition as defined above.

In a preferred embodiment, the polymer present in the molding material is a thermoplastic polymer.

Suitable thermoplastic polymers are all thermoplastically processable polymers. In particular, these thermoplastic polymers are selected from:
homopolymers or copolymers which comprise at least one monomer in polymerized-in form, which is selected from C₂-C₁₀ monoolefins, such as, for example, ethylene or propylene, 1,3-butadiene, 2-chloro-1,3-butadiene, esters of C₂-C₁₀-alkyl acids with vinyl alcohol, vinyl chloride, vinylidene chloride, vinylidene fluoride, tetrafluoroethylene, glycidyl acrylate, glycidyl methacrylate, acrylates and methacrylates with alcohol components of branched and unbranched C₁-C₁₀-alcohols, vinylaromatics such as, for example, styrene, acrylonitrile, methacrylonitrile, maleic anhydride and α,β-ethylenically unsaturated mono- and dicarboxylic acids;
homopolymers and copolymers of vinylacetates,
polyvinyl esters,
polycarbonates (PC);
polyesters, such as polyalkylene terephthalates, polyhydroxyalkanoates (PHA), polybutylene succinates (PBS), polybutylene succinate adipates (PBSA);
polyethers;
polyether ketones;
thermoplastic polyurethanes (TPU);
polysulfides;
polysulfones;
polyethersulfones;
cellulose alkyl esters;

and mixtures thereof.

Mention is to be made, for example, of polyacrylates with identical or different alcohol radicals from the group of C₄-C₈-alcohols, particularly of butanol, hexanol, octanol and 2-ethylhexanol, polymethyl methacrylate (PMMA), methyl methacrylate-butyl acrylate copolymers, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), styrene-maleic anhydride copolymers, styrene-maleic acid copolymers (SMA), polyoxymethylene (POM), polyvinyl alcohol (PVAL), polyvinyl acetate (PVA), polyvinylbutyral (PVB), polycaprolactone (PCL), polyhydroxybutyric acid (PHB), polyhydroxyvaleric acid (PHV), polylactic acid (PLA), ethylcellulose (EC), cellulose acetate (CA), cellulose propionate (CP) or cellulose acetate/butyrate (CAB).

Preferably, the at least one thermoplastic polymer present in the molding material according to the invention is polyvinyl chloride (PVC), polyvinylbutyral (PVB), homopolymers and copolymers of vinyl acetate, homopolymers and copolymers of styrene, polyacrylates, thermoplastic polyurethanes (TPU) or polysulfides.

The present invention further provides molding materials comprising at least one elastomer and at least one plasticizer composition as defined above.

Depending on which thermoplastic polymer or thermoplastic polymer mixture is present in the molding material, different amounts of plasticizer are required to achieve the desired thermoplastic properties. This can be determined by means of a few routine experiments. If the at least one thermoplastic polymer present in the molding material according to the invention is not PVC, the content of the plasticizer composition according to the invention in the molding material is generally 0.5 to 300 phr (parts per hundred resin=parts by weight per hundred parts by weight of polymer), preferably 1.0 to 130 phr, particularly preferably 2.0 to 100 phr.

Specifically, the at least one thermoplastic polymer present in the molding material according to the invention is polyvinyl chloride (PVC).

Polyvinyl chloride is obtained by homopolymerization of vinyl chloride. The polyvinyl chloride (PVC) used according to the invention can be produced for example, by suspension polymerization, microsuspension polymerization, emulsion polymerization or bulk polymerization. The production of PVC by polymerization of vinyl chloride, and preparation and composition of plasticized PVC are described for example in “Becker/Braun, Kunststoff-Handbuch, Band 2/1: Polyvinylchlorid [Plastics Handbook, Volume 2/1: Polyvinyl chloride]”, 2^{nd} edition, Carl Hanser Verlag, Munich.

The K value, which characterizes the molar mass of the PVC and is determined in accordance with DIN 53726 is, for the PVC plasticized according to the invention, mostly in the range from 57 to 90, preferably in the range from 61 to 85, in particular in the range from 64 to 80.

In the context of the invention, the content of PVC in the mixtures is 20 to 95% by weight, preferably 40 to 90% by weight and in particular 45 to 85% by weight.

If the thermoplastic polymer in the molding materials according to the invention is polyvinyl chloride, the total plasticizer content in the molding material is 5 to 300 phr, preferably 15 to 150 phr, particularly preferably 30 to 120 phr.

The present invention further provides molding materials comprising an elastomer and a plasticizer composition according to the invention.

The elastomer present in the molding materials according to the invention may be a natural rubber (NR), or a rubber produced by a synthetic route, or mixtures thereof.

Preferred rubbers produced by a synthetic route are, for example, polyisoprene rubber (IR), styrene-butadiene rubber (SBR), butadiene rubber (BR), nitrile-butadiene rubber (NBR) or chloroprene rubber (CR).

Preference is given to rubbers or rubber mixtures which can be vulcanized with sulfur.

In the context of the invention, the content of elastomer in the molding materials according to the invention is 20 to 95% by weight, preferably 45 to 90% by weight and in particular 50 to 85% by weight, based on the total weight of the molding material.

In the context of the invention, the molding materials which comprise at least one elastomer can comprise other suitable additives in addition to the above constituents.

For example, reinforcing fillers, such as carbon black or silicon dioxide, further fillers, such as phenol resins, vulcanizing or crosslinking agents, vulcanizing or crosslinking accelerators, activators, various types of oil, antiaging agents and other various additives which are mixed for example into tire and other rubber materials may be present.

If the polymer in the molding materials according to the invention is elastomers, specifically rubbers, the content of the plasticizer composition according to the invention, as defined above, in the molding material is 1.0 to 60 phr, preferably 2.0 to 40 phr, particularly preferably 3.0 to 30 phr.

Additionally, the polymer in the molding materials according to the invention can be mixtures of PVC with an elastomer. As regards elastomers that are suitable and preferred for this purpose, reference is made to the preceding statements. The content of the elastomer in these polymer mixtures is usually 1 to 50% by weight, preferably 3 to 40% by weight, in particular 5 to 30% by weight.

Depending on how large the fraction of elastomer in the polymer mixture is, the amount of plasticizer composition according to the invention required to achieve the desired properties in these molding materials can vary greatly.

The content of the plasticizer composition according to the invention in these molding materials is usually in the range from 0.5 to 300 phr, preferably in the range from 1.0 to 150 phr, particularly preferably in the range from 2.0 to 120 phr.

Additives for Molding Material

In the context of the invention, the molding materials comprising at least one thermoplastic polymer can comprise other suitable additives. For example, stabilizers, lubricants, fillers, pigments, flame inhibitors, photostabilizers, blowing agents, polymeric processing auxiliaries, impact improvers, optical lighteners, antistats or biostabilizers may be present.

Some suitable additives are described in more detail below. The examples listed, however, do not constitute a limitation of the molding materials according to the invention but serve merely for explanation. All data relating to content is in % by weight data based on the total molding material.

Suitable stabilizers are all customary PVC stabilizers in solid and liquid form, for example customary Ca/Zn, Ba/Zn, Pb or Sn stabilizers, and also acid-binding sheet silicates.

The molding materials according to the invention can have a content of stabilizers of 0.05 to 7%, preferably 0.1 to 5%, particularly preferably from 0.2 to 4% and in particular from 0.5 to 3%.

Lubricants reduce the adhesion between the plastics to be processed and metal surfaces and serve to counteract forces of friction during the mixing, plastification and molding.

As lubricants, the molding materials according to the invention can comprise all of the lubricants customary for the processing of plastics. Of suitability are, for example, hydrocarbons, such as oils, paraffins and PE waxes, fatty alcohols having 6 to 20 carbon atoms, ketones, carboxylic acids, such as fatty acids and montanic acid, oxidized PE wax, metal salts of carboxylic acids, carboxamides, and carboxylic acid esters, for example with the alcohols ethanol, fatty alcohols, glycerol, ethanediol, pentaerythritol and long-chain carboxylic acids as acid component.

The molding materials according to the invention can have a content of lubricants of 0.01 to 10%, preferably 0.05 to 5%, particularly preferably from 0.1 to 3% and in particular from 0.2 to 2%.

Fillers influence primarily the compression, tensile and flexural strength, and also the hardness and thermostability of plasticized PVC in a positive way.

In the context of the invention, the molding materials can also comprise fillers, such as, for example, carbon black and other inorganic fillers, such as natural calcium carbonates, for example chalk, limestone and marble, synthetic calcium carbonates, dolomite, silicates, silica, sand, diatomaceous earth, aluminum silicates, such as kaolin, mica and feldspar. Preference is given to using calcium carbonates, chalk, dolomite, kaolin, silicates, talc or carbon black as fillers.

The molding materials according to the invention can have a content of fillers of from 0.01 to 80%, preferably 0.1 to 60%, particularly preferably from 0.5 to 50% and in particular from 1 to 40%.

The molding materials according to the invention can also comprise pigments in order to adapt the resulting product to different use possibilities.

In the context of the present invention, both inorganic pigments and organic pigments can be used. Inorganic pigments that can be used are, for example, cobalt pigments, for example CoO/Al₂O₃, and chromium pigments, for example Cr₂O₃. Suitable organic pigments are, for example, monoazo pigments, condensed azo pigments, azomethine pigments, anthraquinone pigments, quinacridones, phthalocyanine pigments and dioxazine pigments.

The molding materials according to the invention can have a content of pigments of from 0.01 to 10%, preferably 0.05 to 5%, particularly preferably from 0.1 to 3% and in particular from 0.5 to 2%.

In order to reduce the flammability and to reduce the formation of smoke upon combustion, the molding materials according to the invention can also comprise flame inhibitors.

Flame inhibitors which can be used are, for example, antimony trioxide, phosphate ester, chloroparaffin, aluminum hydroxide and boron compounds.

The molding materials according to the invention can have a content of flame inhibitors of from 0.01 to 10%, preferably 0.1 to 8%, particularly preferably from 0.2 to 5% and in particular from 0.5 to 2%.

In order to protect articles produced from the molding materials according to the invention against damage in the surface region as a result of the influence of light, the molding materials can also comprise photostabilizers, e.g. UV absorbers.

In the context of the present invention, the photostabilizers used are, for example, hydroxybenzophenones, hydroxyphenylbenzotriazoles, cyanoacrylates or so-called “hindered amine light stabilizers” (HALS), such as the derivatives of 2,2,6,6-tetramethylpiperidine.

The molding materials according to the invention can have a content of photostabilizers, e.g. UV absorbers, of from 0.01 to 7%, preferably 0.1 to 5%, particularly preferably from 0.2 to 4% and in particular from 0.5 to 3%.

Preparaton of the Compurgcs of the General Formula (I)

The polyester plasticizers according to the invention are produced in a manner industrially known per se, as described for example in EP 1423476B1, by esterification of aliphatic dicarboxylic acids with diols in the presence of a monocarboxylic acid as terminating group. The chain length or the average molecular weight of the polyester plasticizers is controlled via the addition ratio of the dicarboxylic acids and the dialcohols.

The dicarboxylic acids which are used for producing the polyester plasticizers of the general formula (I) are preferably unbranched or branched C₂-C₆-alkyldicarboxylic acids, particularly preferably unbranched C₂-C₅-alkyldicarboxylic acids. In particular, the dicarboxylic acids which are used for producing the polyester plasticizers of the general formula (I) are glutaric acid and/or adipic acid, specifically adipic acid.

The diols which are used for producing the polyester plasticizers of the general formula (I) are preferably unbranched or branched C₂-C₈-alkyldiols, such as for example 1,2-ethanediol, 1,2-propanediol, 1,3-propanediol, 1,2-butanediol, 1,3-butanediol, 1,4-butanediol, 1,2-pentanediol, 1,3-pentanediol, 2-methyl-1,3-pentanediol, 2,2-dimethyl-1,3-pentanediol, 1,4-pentanediol, 1,5-pentanediol, 1,2-hexanediol, 1,3-hexanediol, 1,4-hexanediol, 1,5-hexanediol, 1,6-hexanediol or mixtures of these diols. They are particularly preferably unbranched and branched C₂-C₅-alkanediols. In particular, the diols which are used for producing the polyester plasticizers of the general formula (I) are 1,2-propanediol, 1,3-butanediol, 1,4-butanediol, 2,2-dimethyl-1,3-propanediol or mixtures of these diols.

The polyester plasticizers of the general formula (I) according to the invention comprise a monocarboxylic acid as chain termination, preferably acetic acid, propionic acid, 2-ethylhexanoic acid, n-nonanoic acid, isononanoic acid, n-decanoic acid, 2-propyl-heptanoic acid, particularly preferably acetic acid.

Specifically, the plasticizer composition according to the invention comprises a compound of the general formula (I) for whose preparation the following feed materials are used:
adipic acid, 1,2-propanediol and acetic acid
adipic acid, 1,3-butanediol, 1,4-butanediol and acetic acid

The esterification catalysts used are usually the catalysts customary for this purpose, e.g. mineral acids, such as sulfuric acid and phosphoric acids; organic sulfonic acids, such as methanesulfonic acid and p-toluenesulfonic acid; amphoteric catalysts, in particular titanium, tin(IV) or zirconium compounds, such as tetraalkoxytitaniums, e.g. tetrabutoxytitanium, and tin(IV) oxide. The esterification catalyst is used in an effective amount, which is customarily in the range from 0.05 to 10% by weight, preferably 0.1 to 5% by weight, based on the sum of acid component (or anhydride) and alcohol component. Further detailed descriptions for carrying out esterification processes can be found, for example, in U.S. Pat. No. 6,310,235, U.S. Pat. No. 5,324,853, DE-A 2612355 (Derwent abstract No. DW 77-72638 Y) or DE A 1945359 (Derwent abstract No. DW 73-27151 U). Reference is made to the cited documents in their entirety.

The esterification can generally take place at ambient pressure or reduced or increased pressure. Preferably, the esterification is carried out at ambient pressure or reduced pressure.

The esterification can be carried out in the absence of an added solvent or in the presence of an organic solvent.

If the esterification is carried out in the presence of a solvent, it is preferably an organic solvent that is inert under the reaction conditions. These include, for example, aliphatic hydrocarbons, halogenated aliphatic hydrocarbons, aromatic and substituted aromatic hydrocarbons or ethers. Preferably, the solvent is selected from pentane, hexane, heptane, ligroin, petroleum ether, cyclohexane, dichloromethane, trichloromethane, tetrachloromethane, benzene, toluene, xylene, chlorobenzene, dichlorobenzenes, dibutyl ether, THF, dioxane and mixtures thereof.

The esterification is usually carried out in a temperature range from 50 to 250° C.

If the esterification catalyst is carried out under organic acids or mineral acids, the esterification is usually carried out in a temperature range from 50 to 1600° C.

If the esterification catalyst is selected from amphoteric catalysts, the esterification is usually carried out in a temperature range from 100 to 250° C.

The esterification can take place in the absence or in the presence of an inert gas. An inert gas is generally understood as meaning a gas which, under the stated reaction conditions, does not enter into any reactions with the starting materials, reagents, solvents or the resulting products involved in the reaction.

In a preferred embodiment, for example diacid, dialcohol and monoacid, and also isopropyl butyl titanate as esterification catalyst are initially introduced in a reaction vessel, heated firstly to 100 to 150° C. and homogenized by means of stirring. During this, the majority of the water of esterification distills off, and at temperatures above 100° C. is removed by distillation. The reaction mixture is then heated to 200 to 300° C. at atmospheric pressure. Alcohol components that have distilled over are largely removed from the azeotrope with water and returned. Then, the reaction mixture is heated further to 200 to 300° C., a vacuum of 0 mbar to 500 mbar is applied and further water of reaction is removed from the reaction mixture by passing nitrogen through. The reaction mixture is stirred under vacuum and while passing nitrogen through at 200 to 300° C. until the acid number of the reaction mixture has reached a value of <2 mg KOH/g. The mixture is then cooled to 120 to 160° C. and monoacid is added.

Then, vacuum is applied again and the excess acid is removed. Then, the reaction product is filtered again at 50 to 150° C.

The aliphatic dicarboxylic acids, diols and monobasic carboxylic acids used for preparing the compounds of the general formula (I) can either be acquired commercially or be prepared by synthesis routes known in the literature.

Polyester plasticizers of the general formula (I) that can be used are also commercially available polyester plasticizers. Suitable commercially available polyester plasticizers are, for example, polyester plasticizers of the type Palamoll® 632 and type Palamoll® 646, which are supplied by BASF SE, Ludwigshafen.

Preparation of the Compounds of the General Formula I

The compounds of the general formula (II) can either be acquired commercially or be prepared by processes known in the prior art.

As a rule, the preparation of the phthalic acid dialkyl esters takes place by esterification of phthalic acid or suitable derivatives thereof with the corresponding alcohols by customary processes known to the person skilled in the art, as described for example in WO 2010076192 or WO 2010076194. A suitable derivative is phthalic anhydride, for example.

The preparation of the ester compounds of the general formula (I) can also take place by transesterification of esters which are different from the esters of the general formula (II) with the corresponding C₁₀-C₁₂-alcohols by customary processes known to the person skilled in the art. These include the reaction of the di(C₁-C₄)-alkyl esters, in particular the dimethyl or diethyl esters, of the phthalic acid with at least one alcohol R²—OH or R³—OH or mixtures thereof in the presence of a suitable transesterification catalyst.

Suitable transesterification catalysts are the customary catalysts usually used for transesterification reactions which are in most cases also used for esterification reactions. These include e.g. mineral acids, such as sulfuric acid and phosphoric acid; organic sulfonic acids, such as methanesulfonic acid and p-toluenesulfonic acid; or special metal catalysts from the group of tin(IV) catalysts, for example dialkyltin dicarboxylates such as dibutyltin diacetate, trialkyltin alkoxides, monoalkyltin compounds such as monobutyltin dioxide, tin salts such as tin acetate or tin oxides; from the group of titanium catalysts, monomeric and polymeric titanates and titanium chelates such as tetraethyl orthotitanate, tetrapropyl orthotitanate, tetrabutyl orthotitanate, triethanolamine titanate; from the group of zirconium catalysts, zirconates and zirconium chelates such as tetrapropyl zirconate, tetrabutyl zirconate, triethanolamine zirconate; and lithium catalysts such as lithium salts, lithium alkoxides; or aluminum(III), chromium(II), iron(III), cobalt(II), nickel(II) and zinc(II) acetyl acetonate.

The amount of transesterification catalyst used is 0.05 to 5% by weight, preferably 0.10 to 1% by weight. The reaction mixture is preferably heated to the boiling point of the reaction mixture, such that the reaction temperature is between 20° C. and 200° C. depending on the reactants.

The transesterification can take place at ambient pressure or reduced or increased pressure. Preferably, the transesterification is carried out at a pressure of from 0.001 to 200 bar, particularly preferably 0.01 to 5 bar. The lower boiling alcohol cleaved off during the transesterification is distilled off, preferably continuously, for the purpose of shifting the equilibrium of the transesterification reaction. The distillation column required for this is usually directly connected to the transesterification reactor; preferably, it is installed directly on this. In the event of using a plurality of transesterification reactors connected in series, each of these reactors can be equipped with a distillation column, or it is possible, preferably from the last reactor of the transesterification reactor cascade, for the evaporated alcohol mixture to be fed in via one or more collecting lines of a distillation column. The higher boiling alcohol recovered in this distillation is preferably returned again to the transesterification.

In the event of using an amphoteric catalyst, its removal is generally possible by hydrolysis and subsequent removal of the metal oxide formed, e.g. by filtration. Preferably, after the reaction has taken place, the catalyst is hydrolyzed by means of washing with water and the precipitated metal oxide is filtered off. If desired, the filtrate can be subjected to further processing for isolation and/or purification of the product. Preferably, the product is removed by distillation.

The transesterification of the di(C₁-C₄)-alkyl ester, in particular the dimethyl or diethyl ester, of the phthalic acid with at least one alcohol R²—OH or R³—OH or mixtures thereof preferably takes place in the presence of at least one titanium(IV) alcoholate. Preferred titanium(IV) alcoholates are tetrapropoxytitanium, tetrabutoxytitanium or mixtures thereof. Preferably, the alcohol component is used at least in twice the stoichiometric amount, based on the di(C₁-C₄-alkyl) esters used.

The transesterification can be carried out in the absence or presence or an added organic solvent. Preferably, the transesterification is carried out in the presence of an inert organic solvent. Suitable organic solvents are those specified above for the esterification. These include specifically toluene and THF.

The temperature during the transesterification is preferably in a range from 50 to 200° C.

The transesterification can take place in the absence or presence of an inert gas. As a rule, an inert gas is understood as meaning a gas which, under the stated reaction conditions, does not enter into any reactions with the starting materials, reagents or solvents involved in the reaction or the resulting products. Preferably, the transesterification is carried out without adding an inert gas.

A common feature of the processes for the preparation of the compounds of the general formula (II) is that, starting from phthalic acid, phthalic anhydride or other suitable derivatives thereof, an esterification or a transesterification is carried out where the corresponding C₉-C₁₂-alkanols are used as starting materials.

Preferred C₉-C₁₂-alkanols which are used for producing the compounds (II) present in the plasticizer composition can be straight-chain or branched or consist of mixtures of straight-chain and branched C₉-C₁₂-alkanols. These include n-nonanol, isononanol, n-decanol, isodecanol, 2-propylheptanol, 2-propyl-4-methylhexanol, 2-propyl-5-methylhexanol, 2-isopropylheptanol, 2-isopropyl-4-methylhexanol, 2-isopropyl-5-methylhexanol, 2-propyl-4,4-dimethylpentanol, n-undecanol, isoundecanol, n-dodecanol or isododecanol. Particularly preferred C₁₀-C₁₂-alkanols are 2-propylheptanol, 2-propyl-4-methylhexanol, 2-propyl-5-methylhexanol, 2-isopropylheptanol, 2-isopropyl-4-methylhexanol, 2-isopropyl-5-methylhexanol and 2-propyl-4,4-dimethylpentanol. Very particular preference is given to 2-propylheptanol.

The abovementioned alkanols which are used for the preparation of the compounds (I) and/or (II) present in the plasticizer composition can be pure substances or isomer mixtures. Frequently, the abovementioned alkanols which are used for the preparation of the compounds (I) and/or (II) present in the plasticizer composition are isomer mixtures, the composition and degree of purity of which depends on the particular process with which they are synthesized.

Heptanol

The heptanols used for the preparation of the compounds of the general formula (I) can be straight-chain or branched or consist of mixtures of straight-chain and branched heptanols. Preference is given to using mixtures of branched heptanols, also referred to as isoheptanol, which are prepared by the rhodium- or preferably cobalt-catalyzed hydroformylation of dimer propene, available e.g. by the Dimersol® process, and subsequent hydrogenation of the resulting isoheptanals to give an isoheptanol mixture. The thus obtained isoheptanol mixture consists of a plurality of isomers corresponding to its preparation. Essentially straight-chain heptanols can be obtained by the rhodium- or preferably cobalt-catalyzed hydroformylation of 1-hexene and subsequent hydrogenation of the resulting n-heptanal to n-heptanol. The hydroformylation of 1-hexene or dimer propene can take place by processes known per se: in the case of hydroformylation with rhodium catalysts dissolved homogeneously in the reaction medium, it is possible for both uncomplexed rhodium carbonyls, which are formed in situ under the conditions of the hydroformylation reaction in the hydroformylation reaction mixture under the action of synthesis gas e.g. from rhodium salts, as well as complex rhodium carbonyl compounds, in particular complexes with organic phosphines, such as triphenylphosphine, or organophosphites, preferably chelating biphosphites, as described e.g. in U.S. Pat. No. 5,288,918, to be used as catalyst. In the case of the cobalt-catalyzed hydroformylation of these olefins, in general cobalt carbonyl compounds homogeneously soluble in the reaction mixture are used which are formed in situ from cobalt salts under the conditions of the hydroformylation reaction under the action of synthesis gas. If the cobalt-catalyzed hydroformylation is carried out in the presence of trialkyl- or triarylphosphines, the desired heptanols are formed directly as hydroformylation product, meaning that further hydrogenation of the aldehyde function is no longer required.

Of suitability for the cobalt-catalyzed hydroformylation of the 1-hexene or the hexene isomer mixtures are, for example, the industrially established processes explained in Falbe, New Syntheses with Carbon Monoxide, Springer, Berlin, 1980 on pages 162-168, such as the Ruhrchemie process, the BASF process, the Kuhlmann process or the Shell process. Whereas the Ruhrchemie, BASF and the Kuhlmann process operate with non-ligand-modified cobalt carbonyl compounds as catalysts and hexanal mixtures are obtained in the process, the Shell process (DE-A 1593368) uses phosphine- or phosphite-ligand-modified cobalt carbonyl compounds as catalyst which, on account of their additional high hydrogenation activity, lead directly to the hexanol mixtures. Advantageous embodiments for carrying out the hydroformylation with non-ligand-modified cobalt carbonyl complexes are described in detail in DE-A 2139630, DE-A 2244373, DE-A 2404855 and WO 01014297.

For the rhodium-catalyzed hydroformylation of 1-hexene or of the hexene isomer mixtures, it is possible to adapt the industrially established rhodium low-pressure hydroformylation process with triphenylphosphine ligand-modified rhodium carbonyl compounds, as provided in U.S. Pat. No. 4,148,830. Non-ligand-modified rhodium carbonyl compounds can advantageously serve as catalyst for the rhodium-catalyzed hydroformylation of long-chain olefins, such as the hexene isomer mixtures obtained by the aforementioned processes, in which case a higher pressure of 80 to 400 bar is to be established, in contrast to the low pressure process. The implementation of such rhodium high-pressure hydroformylation processes is described in e.g. EP-A 695734, EP-B 880494 and EP-B 1047655.

The isoheptanal mixtures obtained by hydroformylation of the hexene isomer mixtures are catalytically hydrogenated to isoheptanol mixtures in a manner customary per se. For this, preference is given to using heterogeneous catalysts which comprise, as catalytically active component, metals and/or metal oxides of group VI to VIII and of subgroup I of the Periodic Table of the Elements, in particular chromium, molybdenum, manganese, rhenium, iron, cobalt, nickel and/or copper, optionally deposited on a support material such as Al₂O₃, SiO₂ and/or TiO₂. Such catalysts are described e.g. in DE-A 3228881, DE-A 2628987 and DE-A 2445303. Particularly advantageously, the hydrogenation of the isoheptanals is carried out with an excess of hydrogen of from 1.5 to 20% above the stoichiometric amount of hydrogen required for the hydrogenation of the isoheptanals, at temperatures of from 50 to 200° C. and at a hydrogen pressure of from 25 to 350 bar, and, in order to avoid secondary reactions, a small amount of water, advantageously in the form of an aqueous solution of an alkali metal hydroxide or carbonate corresponding to the teaching of WO 01087809 is added to the hydrogenation feed according to DE-A 2628987.

Octanol

2-Ethylhexanol, which was for many years the plasticizer alcohol produced in the largest amounts, can be obtained via the aldol condensation of n-butyraldehyde to 2-ethylhexenal and its subsequent hydrogenation to 2-ethylhexanol (see Ullmann's Encyclopedia of Industrial Chemistry; 5^{th} edition, Vol. A 10, pp. 137-140, VCH Verlagsgesellschaft GmbH, Weinheim 1987).

Essentially straight-chain octanols can be obtained by the rhodium- or preferably cobalt-catalyzed hydroformylation of 1-heptene and subsequent hydrogenation of the resulting n-octanal to n-octanol. The 1-heptene required for this can be obtained from the Fischer-Tropsch synthesis of hydrocarbons.

In contrast to 2-ethylhexanol or n-octanol, the alcohol isooctanol is not, as a result of its mode of preparation, a uniform chemical compound, but an isomer mixture of differently branched C₈-alcohols, for example of 2,3-dimethyl-1-hexanol, 3,5-dimethyl-1-hexanol, 4,5-dimethyl-1-hexanol, 3-methyl-1-heptanol and 5-methyl-1-heptanol, which may be present in the isooctanol in various quantitative ratios depending on the preparation conditions and processes used. Isooctanol is usually prepared by the codimerization of propene with butenes, preferably n-butenes, and subsequent hydroformylation of the mixture of heptene isomers obtained therein. The octanal isomer mixture obtained in the hydroformylation can then be hydrogenated to the isooctanol in a conventional manner per se.

The codimerization of propene with butenes to give isomeric heptenes can advantageously take place with the help of the homogeneously catalyzed Dimersol® process (Chauvin et al.; Chem. Ind.; May 1974, pp. 375-378), in which a soluble nickel-phosphine complex in the presence of an ethylaluminum chlorine compound, for example ethylaluminum dichloride, serves as catalyst. The phosphine ligands used for the nickel complex catalyst may be e.g. tributylphosphine, triisopropylphosphine, tricyclohexylphosphine and/or tribenzylphosphine. The reaction takes place at temperatures from 0 to 80° C., with a pressure advantageously being established at which the olefins are present in dissolved form in the liquid reaction mixture (Cornils; Hermann: Applied Homogeneous Catalysis with Organometallic Compounds; 2^{nd} edition; Vol. 1; pp. 254-259, Wiley-VCH, Weinheim 2002).

Alternatively to the Dimersol® process operated with nickel catalysts dissolved homogeneously in the reaction medium, the codimerization of propene with butenes can also be carried out with heterogeneous NiO catalysts deposited on a support, in which case similar heptene isomer distributions are obtained as in the homogeneously catalyzed process. Such catalysts are used for example in the so-called Octol® process (Hydrocarbon Processing, February 1986, pp. 31-33), a highly suitable specific nickel heterogeneous catalyst for olefin dimerization or codimerization is disclosed e.g. in WO 9514647.

Instead of catalysts based on nickel, it is also possible to use Brønsted-acidic heterogeneous catalysts for the codimerization of propene with butenes, in which case, as a rule, more highly branched heptenes are obtained than in the nickel-catalyzed processes. Examples of catalysts suitable for this purpose are solid phosphoric acid catalysts e.g. kieselguhr or diatomaceous earth impregnated with phosphoric acid, as are used by the PolyGas® process for olefindi- or oligomerization (Chitnis et al.; Hydrocarbon Engineering 10, No. 6, June 2005). Brønsted-acidic catalysts very highly suited for the codimerization of propene and butenes to heptenes are zeolites which the EMOGAS® process further developed on the basis of the PolyGas® process uses.

The 1-heptene and the heptene isomer mixtures are converted to n-octanal or octanal isomer mixtures by the known processes explained above in connection with the preparation of n-heptanal and heptanal isomer mixtures by means of rhodium- or cobalt-catalyzed hydroformylation, preferably cobalt-catalyzed hydroformylation. These are then hydrogenated to the corresponding octanols e.g. by means of one of the catalysts specified above in connection with the n-heptanol and isoheptanol preparation.

Nonanol

Essentially straight-chain nonanol can be obtained by the rhodium- or preferably cobalt-catalyzed hydroformylation of 1-octene and subsequent hydrogenation of the n-nonanal resulting therein. The starting olefin 1-octene can be obtained for example via an ethylene oligomerization by means of a nickel complex catalyst homogeneously soluble in the reaction medium—1,4-butanediol—with e.g. diphenylphosphinoacetic acid or 2-diphenylphosphinobenzoic acid as ligands. This process is also known under the name Shell Higher Olefins Process or SHOP process (see Weisermel, Arpe: Industrielle Organische Chemie [Industrial Organic Chemistry]; 5^{th} edition, p. 96; Wiley-VCH, Weinheim 1998).

Isononanol, which is used for the synthesis of the diisononyl esters of the general formulae (I) and (II) present in the plasticizer composition according to the invention, is not a uniform chemical compound, but a mixture of differently branched isomeric C₉-alcohols which, depending on the nature of their preparation, in particular also of the starting materials used, can have different degrees of branching. In general, the isononanols are prepared by dimerization of butenes to isooctene mixtures, subsequent hydroformylation of the isooctene mixtures and hydrogenation of the isononanal mixtures obtained therein to give isononanol mixtures, as explained in Ullmann's Encyclopedia of Industrial Chemistry, 5^{th} edition, Vol. A1, p. 291-292, VCH Verlagsgesellschaft GmbH, Weinheim 1995.

Starting materials for producing the isonanols that can be used are isobutene, cis- and trans-2-butene as well as 1-butene or mixtures of these butene isomers. During the dimerization of pure isobutene, catalyzed predominantly by means of liquid, e.g. sulfuric acid or phosphoric acid, or solid e.g. phosphoric acid applied to kieselguhr, SiO₂ or Al₂O₃ as support material, or zeolites or Brønsted acids, the highly branched 2,4,4-trimethylpentene, also referred to diisobutylene, is predominantly obtained which, after hydroformylation and hydrogenation of the aldehyde, produces highly branched isonanols.

Preference is given to isononanols with a lower degree of branching. Such low-branched isononanol mixtures are prepared from the linear butenes 1-butene, cis- and/or trans-2-butene, which can optionally also comprise relatively small amounts of isobutene, via the route of butene dimerization described above, hydroformylation of the isooctene and hydrogenation of the resulting isononanal mixtures. A preferred raw material is the so-called raffinate II, which is obtained from the C₄ cut of a cracker, for example of a steam cracker, which is obtained after elimination from allenes, acetylenes and dienes, in particular 1,3-butadiene, by its partial hydrogenation to linear butenes or its removal by extractive distillation, for example by means of N-methylpyrrolidone, and subsequent Brønsted-acid-catalyzed removal of the isobutene present therein by its reaction with methanol or isobutanol by industry-established processes with the formation of the fuel additive methyl tert-butyl ether (MTBE) or of the isobutyl tert-butyl ether serving to obtain pure isobutene.

Raffinate II comprises, besides 1-butene and cis- and trans-2-butene, also n- and isobutane and residual amounts of up to 5% by weight of isobutene.

The dimerization of the linear butenes or of the butene mixture present in raffinate II can be carried out by means of customary processes practiced industrially, as have been explained above in connection with generating isoheptene mixtures, for example by means of heterogeneous, Brønsted-acidic catalysts, as are used in the PolyGas® or EMOGAS® process, by means of the Dimersol® process using nickel complex catalysts dissolved homogeneously in the reaction medium or by means of heterogeneous catalysts containing nickel(II) oxide by the Octol® process or the process according to WO 9514647. The isooctene mixtures obtained therein are converted to isononanal mixtures by the known processes explained above in connection with the preparation of heptanal isomer mixtures by means of rhodium- or cobalt-catalyzed hydroformylation, preferably cobalt-catalyzed hydroformylation. Said isononanal mixtures are then hydrogenated to the suitable isononanol mixtures by means of one of the catalysts specified above in connection with the isoheptanol preparation.

The isononanol isomer mixtures prepared in this way can be characterized via their isoindex, which can be calculated from the degree of branching of the individual isomeric isononanol components in the isononanol mixture multiplied by their percentage fraction in the isononanol mixture. Thus, e.g. n-nonanol with the value 0, methyloctanols (one branch) with the value 1 and dimethylheptanols (two branches) with the value 2 contribute to the isoindex of an isononanol mixture. The higher the linearity, the lower the isoindex of the isononanol mixture in question. Accordingly, the isoindex of an isononanol mixture can be ascertained by gas chromatographic separation of the isononanol mixture into its individual isomers and associated quantification of their percentage quantitative fraction in the isononanol mixture, determined by standard methods of gas chromatographic analysis. For the purpose of increasing the volatility and improving the gas chromatographic separation of the isomeric nonanols, these are expediently trimethylsilylated before the gas chromatographic analysis by means of standard methods, for example by reaction with N-methyl-N-trimethylsilyltrifluoroacetamide. In order to achieve as good as possible a separation of the individual components during the gas chromatographic analysis, capillary columns with polydimethylsiloxane are preferably used as the stationary phase. Such capillary columns are commercially available, and it merely requires a few routine experiments by the person skilled in the art in order to select a brand optimally suitable for this separation task from the diverse supply on the market.

The diisononyl esters of the general formulae (I) and (II) used in the plasticizer composition according to the invention are generally esterified with isononanols with an isoindex of 0.8 to 2, preferably from 1.0 to 1.8 and particularly preferably from 1.1 to 1.5, which can be prepared by the processes given above.

Merely by way of example, possible compositions of isononanol mixtures as can be used for the preparation of the compounds of the general formulae (I) and (II) used according to the invention are given below, it being necessary to note that the fractions of the isomers specifically listed in the isononanol mixture can vary depending on the composition of the starting material, for example raffinate II, the composition of butenes of which can vary depending on production, and on fluctuations in the applied production conditions, for example the age of the catalysts used and temperature and pressure conditions to be adapted thereto.

For example, an isononanol mixture which has been prepared by cobalt-catalyzed hydroformylation and subsequent hydrogenation from an isooctene mixture produced using raffinate II as raw material by means of the catalyst and process according to WO 9514647, can have the following composition:
1.73 to 3.73% by weight, preferably 1.93 to 3.53% by weight, particularly preferably 2.23 to 3.23% by weight of 3-ethyl-6-methylhexanol;
0.38 to 1.38% by weight, preferably 0.48 to 1.28% by weight, particularly preferably 0.58 to 1.18% by weight of 2,6-dimethylheptanol;
2.78 to 4.78% by weight, preferably 2.98 to 4.58% by weight, particularly preferably 3.28 to 4.28% by weight of 3,5-dimethylheptanol;
6.30 to 16.30% by weight, preferably 7.30 to 15.30% by weight, particularly preferably 8.30 to 14.30% by weight of 3,6-dimethylheptanol;
5.74 to 11.74% by weight, preferably 6.24 to 11.24% by weight, particularly preferably 6.74 to 10.74% by weight of 4,6-dimethylheptanol;
1.64 to 3.64% by weight, preferably 1.84 to 3.44% by weight, particularly preferably 2.14 to 3.14% by weight of 3,4,5-trimethylhexanol;
1.47 to 5.47% by weight, preferably 1.97 to 4.97% by weight, particularly preferably 2.47 to 4.47% by weight of 3,4,5-trimethylhexanol, 3-methyl-4-ethylhexanol and 3-ethyl-4-methylhexanol;
4.00 to 10.00% by weight, preferably 4.50 to 9.50% by weight, particularly preferably 5.00 to 9.00% by weight of 3,4-dimethylheptanol;
0.99 to 2.99% by weight, preferably 1.19 to 2.79% by weight, particularly preferably 1.49 to 2.49% by weight of 4-ethyl-5-methylhexanol and 3-ethylheptanol;
2.45 to 8.45% by weight, preferably 2.95 to 7.95% by weight, particularly preferably 3.45 to 7.45% by weight of 4,5-dimethylheptanol and 3-methyloctanol;
1.21 to 5.21% by weight, preferably 1.71 to 4.71% by weight, particularly preferably 2.21 to 4.21% by weight of 4,5-dimethylheptanol;
1.55 to 5.55% by weight, preferably 2.05 to 5.05% by weight, particularly preferably 2.55 to 4.55% by weight of 5,6-dimethylheptanol;
1.63 to 3.63% by weight, preferably 1.83 to 3.43% by weight, particularly preferably 2.13 to 3.13% by weight of 4-methyloctanol;
0.98 to 2.98% by weight, preferably 1.18 to 2.78% by weight, particularly preferably 1.48 to 2.48% by weight of 5-methyloctanol;
0.70 to 2.70% by weight, preferably 0.90 to 2.50% by weight, particularly preferably 1.20 to 2.20% by weight of 3,6,6-trimethylhexanol;
1.96 to 3.96% by weight, preferably 2.16 to 3.76% by weight, particularly preferably 2.46 to 3.46% by weight of 7-methyloctanol;
1.24 to 3.24% by weight, preferably 1.44 to 3.04% by weight, particularly preferably 1.74 to 2.74% by weight of 6-methyloctanol;
0.1 to 3% by weight, preferably 0.2 to 2% by weight, particularly preferably 0.3 to 1% by weight of n-nonanol;
25 to 35% by weight, preferably 28 to 33% by weight, particularly preferably 29 to 32% by weight, of other alcohols having 9 and 10 carbon atoms;
with the proviso that the total sum of the stated components is 100% by weight.

Corresponding to the above statements, an isononanol mixture which has been prepared by cobalt-catalyzed hydroformylation and subsequent hydrogenation using an ethylene-containing butene mixture as raw material by means of the PolyGas® or EMOGAS® process produced isooctene mixture can vary in the range of the following compositions, depending on the raw material composition and fluctuations in the applied reaction conditions:
6.0 to 16.0% by weight, preferably 7.0 to 15.0% by weight, particularly preferably 8.0 to 14.0% by weight of n-nonanol;
12.8 to 28.8% by weight, preferably 14.8 to 26.8% by weight, particularly preferably 15.8 to 25.8% by weight of 6-methyloctanol;
12.5 to 28.8% by weight, preferably 14.5 to 26.5% by weight, particularly preferably 15.5 to 25.5% by weight of 4-methyloctanol;
3.3 to 7.3% by weight, preferably 3.8 to 6.8% by weight, particularly preferably 4.3 to 6.3% by weight of 2-methyloctanol;
5.7 to 11.7% by weight, preferably 6.3 to 11.3% by weight, particularly preferably 6.7 to 10.7% by weight of 3-ethylheptanol;
1.9 to 3.9% by weight, preferably 2.1 to 3.7% by weight, particularly preferably 2.4 to 3.4% by weight, of 2-ethylheptanol;
1.7 to 3.7% by weight, preferably 1.9 to 3.5% by weight, particularly preferably 2.2 to 3.2% by weight of 2-propylhexanol;
3.2 to 9.2% by weight, preferably 3.7 to 8.7% by weight, particularly preferably 4.2 to 8.2% by weight, of 3,5-dimethylheptanol;
6.0 to 16.0% by weight, preferably 7.0 to 15.0% by weight, particularly preferably 8.0 to 14.0% by weight, of 2,5-dimethylheptanol;
1.8 to 3.8% by weight, preferably 2.0 to 3.6% by weight, particularly preferably 2.3 to 3.3% by weight, of 2,3-dimethylheptanol;
0.6 to 2.6% by weight, preferably 0.8 to 2.4% by weight, particularly preferably 1.1 to 2.1% by weight, of 3-ethyl-4-methylhexanol;
2.0 to 4.0% by weight, preferably 2.2 to 3.8% by weight, particularly preferably 2.5 to 3.5% by weight, of 2-ethyl-4-methylhexanol;
0.5 to 6.5% by weight, preferably 1.5 to 6% by weight, particularly preferably 1.5 to 5.5% by weight, of other alcohols having 9 carbon atoms;
with the proviso that the total sum of the stated components is 100% by weight.

Decanol

Isodecanol, which is used for the synthesis of the diisodecyl esters of the general formulae (I) and (II) present in the plasticizer composition according to the invention, is not a uniform chemical compound, but a complex mixture of differently branched isomeric decanols.

These are generally prepared by the nickel- or Brønsted-acid-catalyzed trimerization of propylene, for example by the PolyGas® or EMOGAS® process explained above, subsequent hydroformylation of the isononene isomer mixture obtained therein by means of homogeneous rhodium- or cobalt carbonyl catalysts, preferably by means of cobalt carbonyl catalysts and hydrogenation of the resulting isodecanal isomer mixture, e.g. by means of the catalysts and processes specified above in connection with the preparation of C₇-Cₐ-alcohols (Ullmann's Encyclopedia of Industrial Chemistry; 5^{th} edition, Vol. A1, p. 293, VCH Verlagsgesellschaft GmbH, Weinheim 1985). The thus produced isodecanol is generally highly branched.

2-Propylheptanol, which is used for the synthesis of the di(2-propylheptyl) esters of the general formula (II) present in the plasticizer composition according to the invention, may be pure 2-propylheptanol or propylheptanol isomer mixtures as are generally formed during the industrial preparation of 2-propylheptanol and are generally likewise referred to as 2-propylheptanol.

Pure 2-propylheptanol can be obtained by aldol condensation of n-valeraldehyde and subsequent hydrogenation of the 2-propylheptenals formed therein, for example in accordance with U.S. Pat. No. 2,921,089. In general, besides the main component 2-propyl-heptanol, commercially available 2-propylheptanol comprises, as a result of the preparation, one or more of the 2-propylheptanol isomers 2-propyl-4-methylhexanol, 2-propyl-5-methylhexanol, 2-isopropylheptanol, 2-isopropyl-4-methylhexanol, 2-isopropyl-5-methylhexanol and/or 2-propyl-4,4-dimethylpentanol. The presence of other isomers of 2-propylheptanol, for example 2-ethyl-2,4-dimethylhexanol, 2-ethyl-2-methylheptanol and/or 2-ethyl-2,5-dimethylhexanol in the 2-propylheptanol is possible; on account of the low formation rates of the aldehydic precursors of these isomers in the course of the aldol condensation, these are only present in trace amounts, if at all, in the 2-propylheptanol and play virtually no role for the plasticizer properties of the compounds produced from such 2-propylheptanol isomer mixtures.

Various hydrocarbon sources can be used as starting material for the preparation of 2-propylheptanol, for example 1-butene, 2-butene, raffinate I—an alkane/alkene mixture obtained from the C₄ cut of a cracker after separating off allenes, aceylenes and dienes and which comprises, besides 1- and 2-butene, also considerable amounts of isobutene—or raffinate II, which is obtained from raffinate I by separating of isobutene and comprises, as olefin components, apart from 1- and 2-butene, only small fractions of isobutene. Mixtures of raffinate I and raffinate II can of course also be used as raw material for the preparation of 2-propylheptanol. These olefins or olefin mixtures can be hydroformylated by conventional methods per se with cobalt or rhodium catalysts, with a mixture of n- and isovaleraldehyde—the name isovaleraldehyde refers to the compound 2-methylbutanal—being formed from 1-butene, the n/iso ratio of which can vary within relatively wide limits depending on the catalyst and hydroformylation conditions used. For example, when using a triphenylphosphine-modified homogeneous rhodium catalyst (Rh/TPP), n- and isovaleraldehyde is formed from 1-butene in an n/iso ratio of in general 10:1 to 20:1, whereas when using rhodium hydroformylation catalysts modified with phosphite ligands, for example in accordance with U.S. Pat. No. 5,288,918 or WO 05028407, or rhodium hydroformylation catalysts modified with phosphoamidite ligands, for example according to WO 0283695, virtually exclusively n-valeraldehyde is formed. Whereas the RhiTPP catalyst system only converts 2-butene very slowly during the hydroformylation, such that the majority of the 2-butene can be recovered again from the hydroformylation mixture, the hydroformylation of 2-butene is successful with the mentioned phosphite ligand- or phosphoramidite ligand-modified rhodium catalysts, with predominantly n-valeraldehyde being formed. By contrast, isobutene present in the olefinic raw material is hydroformylated, albeit at different rate, by virtually all catalyst systems to give 3-methylbutanal and, depending on the catalyst, to give pivalaldehyde to a lesser extent.

The C₅-aldehydes obtained depending on the starting materials and catalysts used, i.e. n-valeraldehyde optionally in a mixture with isovaleraldehyde, 3-methylbutanal and/or pivalaldehyde, can, if desired, be separated completely or partially by distillation into the individual components prior to the aldol condensation, meaning that, here too, there is the option to influence and control the isomer composition of the C₁₀-alcohol component of the ester mixtures used according to the invention. It is also possible to feed to the aldol condensation the C₅-aldehyde mixture as it is formed during the hydroformylation, without separating off individual isomers beforehand. During the aldol condensation, which can be carried out by means of a basic catalyst, such as an aqueous solution of sodium hydroxide or potassium hydroxide, for example in accordance with the processes described in EP-A 366089, U.S. Pat. No. 4,426,524 or U.S. Pat. No. 5,434,313, when using n-valeraldehyde as the sole condensation product, 2-propylheptenal is formed, whereas when using a mixture of isomeric C₅-aldehydes an isomer mixture of the products of the homoaldol condensation of identical aldehyde molecules and the crossed aldol condensation of different valeraldehyde isomers is formed. The aldol condensation can of course be controlled through the targeted reaction of individual isomers in such a way that predominantly or completely an individual aldol condensation isomer is formed. The aldol condensation products in question can then be hydrogenated to the corresponding alcohols or alcohol mixtures, usually after prior, preferably distillative separation from the reaction mixture and, if desired, distillative purification, using conventional hydrogenation catalysts, for example those specified above for the hydrogenation of aldehydes.

As already mentioned, the compounds of the general formula (II) present in the plasticizer composition according to the invention can be esterified with pure 2-propyl-heptanol. In general, however, for the preparation of these esters, mixtures of 2-propylheptanol with the specified propylheptanol isomers are used in which the content of 2-propyheptanol is at least 50% by weight, preferably 60 to 98% by weight and particularly preferably 80 to 95% by weight, especially 85 to 95% by weight.

Suitable mixtures of 2-propylheptanol with the propylheptanol isomers comprise for example those of 60 to 98% by weight of 2-propylheptanol, 1 to 15% by weight of 2-propyl-4-methylhexanol and 0.01 to 20% by weight of 2-propyl-5-methylhexanol and 0.01 to 24% by weight of 2-isopropylheptanol, with the sum of the fractions of the individual constituents not exceeding 100% by weight. Preferably, the fractions of the individual constituents add up to 100% by weight.

Further suitable mixtures of 2-propylheptanol with the propylheptanol isomers comprise, for example, those of 75 to 95% by weight of 2-propylheptanol, 2 to 15% by weight of 2-propyl-4-methylhexanol, 1 to 20% by weight of 2-propyl-5-methylhexanol, 0.1 to 4% by weight of 2-isopropylheptanol, 0.1 to 2% by weight of 2-isopropyl-4-methylhexanol and 0.1 to 2% by weight of 2-isopropyl-5-methylhexanol, where the sum of the fractions of the individual constituents does not exceed 100% by weight. Preferably, the fractions of the individual constituents add up to 100% by weight.

Preferred mixtures of 2-propylheptanol with the propylheptanol isomers comprise those with 85 to 95% by weight of 2-propylheptanol, 5 to 12% by weight of 2-propyl-4-methylhexanol and 0.1 to 2% by weight of 2-propyl-5-methylhexanol and 0.01 to 1% by weight of 2-isopropylheptanol, where the sum of the fractions of the individual constituents does not exceed 100% by weight. Preferably, the fractions of the individual constituents add up to 100% by weight.

When using the specified 2-propylheptanol isomer mixtures instead of pure 2-propylheptanol for the preparation of the compounds of the general formulae (I) and (II), the isomer composition of the alkyl ester groups or alkyl ether groups corresponds virtually to the composition of the propylheptanol isomer mixtures used for the esterification.

Undecanol

The undecanols which are used for the preparation of the compounds of the general formulae (I) and (II) present in the plasticizer composition according to the invention can be straight-chain or branched or be composed of mixtures of straight-chain and branched undecanols. Preference is given to using mixtures of branched undecanols, also referred to as isoundecanol, as alcohol component.

Essentially straight-chain undecanol can be obtained by the rhodium- or preferably cobalt-catalyzed hydroformylation of 1-decene and subsequent hydrogenation of the n-undecanal obtained therein. The starting olefin 1-decene is prepared via the SHOP process mentioned previously for the preparation of 1-octene.

To prepare branched isoundecanol, the 1-decene obtained in the SHOP process can be subjected to a skeletal isomerization, e.g. by means of acidic zeolitic molecular sieve, as described in WO 9823566, with mixtures of isomeric decenes being formed, their rhodium- or preferably cobalt-catalyzed hydroformylation and subsequent hydrogenation of the resulting isoundecanal mixtures leads to the isoundecanol used for the preparation of the compounds (I) and (I) used according to the invention. The hydroformylation of 1-decene or isodecene mixtures by means of rhodium or cobalt catalysis can take place as described above in connection with the synthesis of C₇- to C₁₀-alcohols. The same is true for the hydrogenation of n-undecanal or isoundecanal mixtures to n-undecanol and isoundecanol, respectively.

Following distillative purification of the discharge of the hydrogenation, the C₇- to C₁₁-alkyl alcohols thus obtained, or mixtures thereof, as described above, can be used for the preparation of the diester compounds of the general formulae (I) or (II) used according to the invention.

Dodecanol

Essentially straight-chain dodecanol can advantageously be obtained via the Alfol® or Epal® process. These processes involve the oxidation and hydrolysis of straight-chain trialkylaluminum compounds, which are built up starting from triethylaluminum in steps via several ethylation reactions using Ziegler-Natta catalysts. The desired n-dodecanol can be obtained from the mixtures, resulting therefrom, of largely straight-chain alkyl alcohols of different chain length following the distillative discharge of the C₁₂-alkyl alcohol fraction.

Alternatively, n-dodecanol can also be prepared by hydrogenation of natural fatty acid methyl esters, for example from coconut oil.

Branched isododecanol can be obtained analogously to the known processes for the codimerization and/or oligomerization of olefins, as described for example in WO 0063151, with subsequent hydroformylation and hydrogenation of the isoundecene mixtures, as described for example in DE-A 4339713. Following distillative purification of the discharge of the hydrogenation, the thus obtained isododecanols or mixtures thereof, can be used, as described above, for the preparation of the diester compounds of the general formulae (I) or (II) used according to the invention.

Molding Material Applications

The molding material according to the invention is preferably used for producing moldings, profiles and films. These include, in particular, housing of electrical devices, such as, for example, kitchen appliances and computer housings; tools; apparatuses; pipelines; cables; hoses, such as, for example, plastic hoses, water and irrigation hoses, industry rubber hoses or chemistry hoses; wire sheaths; window profiles; plastic profiles for e.g. conveyor belts; components for vehicle construction, such as, for example, car body constituents, vibration dampers for engines; tires; furniture, such as, for example, chairs, tables or benches; foam for upholstery and mattresses; tarpaulins, such as, for example, lorry tarpaulins, flysheets or roofing sheets; seals; composite films, such as films for composite safety glass, in particular for vehicle and window panes; self-adhesive films; laminate films; flysheets, roofing sheets; records; synthetic leather; packaging containers; adhesive tape films or coatings.

In addition, the molding material according to the invention is additionally suitable for producing moldings and films which come into direct contact with people or foods.

These are predominantly medical products, hygiene products, food packagings, products for interiors, toys and childcare articles, sport and leisure products, clothing or fibers for fabric and the like.

The medical products which can be produced from the molding material according to the invention are, for example, tubes for enteral feeding and hemodialysis, breathing tubes, infusion tubes, infusion bags, blood bags, catheters, tracheal tubes, single-use syringes, gloves or breathing masks.

The food packagings which can be produced from the molding material according to the invention are, for example, cling films, food tubes, drinking water tubes, containers for storing or freezing foods, lid seals, closure caps, crown caps or synthetic wine corks.

Products for interiors which can be produced from the molding material according to the invention are, for example, floor coverings, which can be composed homogeneously or of several layers consisting of at least one foamed layer, such as, for example, foot floor coverings, sports floors or luxury vinyl tiles (LVT), synthetic leather, wall coverings or foamed or nonfoamed carpets in buildings or claddings or console covers in vehicles.

The toys and childcare articles which can be produced from the molding material according to the invention are, for example, dolls, inflatable toys such as balls, play pieces, toy animals, anatomical models for education, modeling clay, swimming aids, pram covers, changing mats, hot-water bottles, teething rings or bottles.

The sport and leisure products which can be produced from the molding material according to the invention are, for example, gymnastic balls, exercise mats, floor cushions, massage balls and rolls, shoes or shoe soles, balls, air mattresses or drinking bottles.

The clothing which can be produced from the molding materials according to the invention is, for example, (coated) textiles, such as latex clothing, protective clothing or rainwear, such as rain jackets or rubber boots.

Non-PVC Applications

Furthermore, the present invention includes the use of the plasticizer composition according to the invention as auxiliary and/or in auxiliaries, selected from: calendering auxiliaries; rheology auxiliaries; surface-active compositions such as flow aids, film binding aids, antifoams, defoamers, wetting agents, coalescence agents and emulsifiers; lubricants, such as lubricating oils, lubricating greases and lubricating pastes; quenching agents for chemical reactions; phlegmatizing agents;
pharmaceutical products; plasticizers in plastics or sealants; impact modifiers and extenders.

The invention is described in more detail by reference to the figures and examples described below. In this connection, the figures and examples are not intended to be understood as being limiting for the invention.

### DESCRIPTION OF THE FIGURES

FIG. 1 shows the plasticizer compatibility of flexible PVC films comprising 100 phr of the plasticizer composition used according to the invention and, as comparison, flexible PVC films comprising exclusively the commercially available plasticizer Palatinoll® 10-P (10-P) or Palamoll® 632 (632). The loss in dry weight [percent] as a function of test time (storage time) [days] is shown.

### EXAMPLES

The following feed materials are used in the examples:

| Feed material | Manufacturer |
|---|---|
| Suspension PVC, | INOVYN ChlorVinyls Limited, |
| trade name Solvin ® 271 SP | London, UK |
| Polyester plasticizer based on | BASF SE, Ludwigshafen, Germany |
| adipic acid, 1,2-propanediol | |
| and acetic acid, trade name | |
| Palamoll ® 632 | |
| Di(2-propylheptyl) phthalate, | BASF SE, Ludwigshafen, Germany |
| Palatinol ® 10-P type | |
| (abbreviation: 10-P) | |
| Ba—Zn stabilizer, | Reagens S.p.A., Bologna, Italy |
| trade name Reagens ® SLX/781 | |

Determination of Molar Mass

The number-average and the weight-average molar mass were measured by means of gel permeation chromatography (GPC). The GPC was carried out on a GPC System Infinity 1100 instrument from Agilent Technologies, consisting of pump, column heating, columns and with a DRI Agilent 1200 detector. The eluent is THF, which flows at a flow rate of 1 ml/min through a column combination of two Agilent PLgel mixed-E columns heated to 35° C. The samples, dissolved in THF in a concentration of 2 mg/ml, are filtered prior to injection over a Macherey-Nagel PTFE-20/25 (0.2 μm) filter. 100 μl were injected. The measurement values obtained were evaluated via a calibration curve which was obtained beforehand with narrowly distributed polystyrene standard from Polymer Laboratories with molecular weights of M=162 to M=50 400.

I. Preparation and Testing of Flexible PVC Films Produced Using Plasticizer Compositions According to the Invention and Using Commercially Available Plasticizers:

Formulation

| Additive | phr |
|---|---|
| PVC (homopolymeric suspension PVC, trade name | 100 |
| Solvin ® 271 SP) | |
| Plasticizer composition according to the invention | 100 |
| Ba—Zn stabilizer, trade name Reagens ® SLX/781 | 2 |

Plasticizer Compositions Used

Plasticizer composition

| | Palamoll ® 632 | Palatinol ® 10-P |
|---|---|---|
| Example | Content/% | Content/% |
| 1 | 80 | 20 |
| 2 | 60 | 40 |
| 3 | 50 | 50 |
| C1 | 100 | 0 |
| C2 | 0 | 100 |

I.a Preparation of Flexible PVC Films

150 g of PVC (homopolymeric suspension PVC, trade name Solvin® 271 SP); 150 g of plasticizer composition and 2 g of Ba/Zn stabilizer, trade name Reagens® SLX/781 were mixed using a handmixer at room temperature. The mixture was then plasticized on an oil-heated laboratory mixing roll mill (Collin, Automatikwalzwerk model 150, diameter: 252 mm, width: 450 mm) and processed to give a rolled sheet. The temperature of the two rollers was in each case 180° C.; the spinning speeds were 15 revolutions/min (front roller) and 12 revolutions/min (rear roller); the rolling time was 5 minutes.

This gave a rolled sheet with a thickness of 0.53 mm. The cooled rolled sheet was then pressed at a temperature of 190° C. and a pressure of 150 bar over the course of 180 s on a press of the type “laboratory plate press 400 P” from Collin to give a flexible PVC film with a thickness of 0.50 mm.

I.b Testing the Compatibility of the Plasticizer in the Flexible PVC Films

Purpose of the Investigation

The test serves for the quantitative measurement of the compatibility of plasticizers in flexible PVC formulations. It is carried out at elevated temperature (70° C.) and 100% relative atmospheric humidity. The data obtained are evaluated against the storage time.

Sample Bodies

Sample bodies (films) with a size of 75×110×0.5 mm are used for the test. The films are perforated along the broad side, inscribed (soldering iron) and weighed.

Test Instruments

Heraeus drying cabinet at 70° C., analytical balance, temperature measuring device Testotherm with sensor for measuring inside the drying cabinet.

Procedure

The temperature inside the drying cabinet is set to the required 70° C. The ready weighed films are suspended on a wire frame and placed into a glass tank filled approx. 5 cm with water (demin. water). It should be ensured that the films do not touch each other. The lower edges of the films must not hang in the water. The glass trough is sealed steam-tight with a polyethylene film so that the steam that is formed later in the glass trough is unable to escape. The water level in the glass beaker is monitored daily and any missing water is replaced.

Storage Time

After 7, 14 and 28 days, in each case 2 films are removed from the glass trough and climatized for 1 hour freely hanging in the air. Then, the films are cleaned on the surface with methanol. The films are then dried freely hanging for 16 h at 70° C. in a drying cabinet with forced convection. After removal from the drying cabinet, the films are climatized freely hanging for 1 hour and then weighed. The arithmetic mean of the weight losses of the films is given in each case.

Results

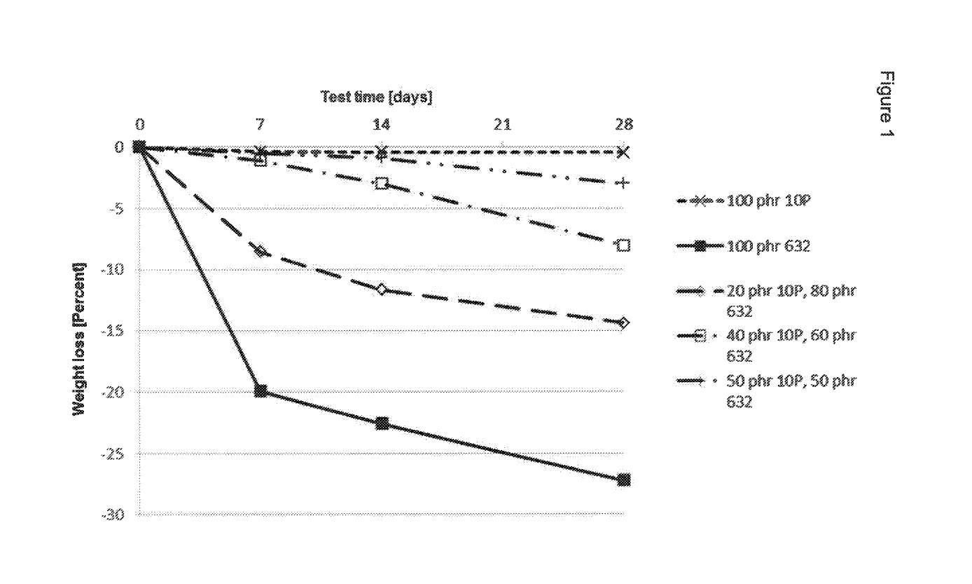

FIG. 1 shows the results of the compatibility tests of PVC films which have been produced using the plasticizer compositions according to the invention (examples 1 to 3) and also using the pure polymer or monomer plasticizers (comparative examples 1 and 2). The loss in dry weight [percent] as a function of test time (storage time) [days] is shown.

As can be seen very readily in FIG. 1, the pure polymer plasticizer Palamoll® 632 has very poor compatibility with PVC. The weight loss in the compatibility test after 28 days is around 27%. Even the addition of only 20 phr of Palatinol® 10-P leads, for an identical total plasticizer content of 100 phr, to a significant reduction in the weight loss of plasticizer by almost half and therefore to a considerable improvement in compatibility. By further increasing the addition of Palatinol® 10-P for an identical total plasticizer content, it is possible to reduce the weight loss in the compatibility test more disproportionately.

1.-23. (canceled)

24. A plasticizer composition comprising
a) one or more compounds of the general formula (I), 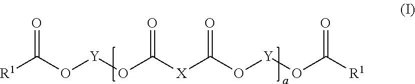
in which
X is in each case an unbranched or branched C₂-C₈-alkylene group or an unbranched or branched C₂-C₈-alkenylene group, comprising at least one double bond,
Y is in each case an unbranched or branched C₂-C₁₂-alkylene group or an unbranched or branched C₂-C₁₂-alkenylene group, comprising at least one double bond,
a is an integer from 1 to 100 and
R¹ independently of one another are selected from unbranched or branched C₁-C₁₂-alkyl radicals,
where the groups Y present in the compounds (I) can be identical or different and where if the compounds (I) comprise more than one group X, these may be identical or different,
and
b) one or more compounds of the general formula (II), 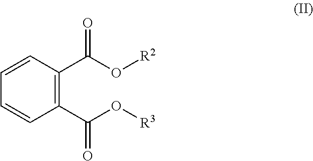
in which
R² and R³, independently of one another, are selected from branched and unbranched C₉-C₁₂-alkyl radicals.

25. The plasticizer composition according to claim 24, where the weight-average molar mass of the compounds (I) is in the range from 500 to 15 000 g/mol.

26. The plasticizer composition according to claim 24, where, in the compound of the general formula (I), X is in each case a branched or unbranched C₂-C₆-alkylene group and Y is in each case a branched or unbranched C₂-C₅-alkylene group.

27. The plasticizer composition according to claim 24, where, in the compound of the general formula (I), the groups Y are not all identical and if in the compound of the general formula (I) a plurality of groups X are present, these are identical.

28. The plasticizer composition as claimed in claim 24, where, in the compounds of the general formula (I), R¹ is, independently of the others, methyl, ethyl, n-propyl, isopropyl, n-butyl, isobutyl, n-pentyl, 2-pentyl, 2-methylbutyl, 3-methylbutyl, n-hexyl, 1-methylpentyl, 2-methylpentyl, 1-ethylbutyl, 2-ethylbutyl, n-heptyl, 1-methylhexyl, 2-methylhexyl, 1-ethylpentyl, 2-ethylpentyl, 1-propylbutyl, n-octyl, isooctyl or 2-ethylhexyl.

29. The plasticizer composition according to claim 24, where, in the compounds of the general formula (I), R¹ are both methyl, both ethyl, both n-propyl, both isopropyl, both n-butyl, both isobutyl or both n-pentyl.

30. The plasticizer composition according to claim 24, where, in the compounds of the general formula (II), R² and R³ are both 2-propylheptyl.

31. The plasticizer composition according to claim 24, where the plasticizer composition optionally comprises a further plasticizer different from the compounds (I) and (II) which is selected from phthalic acid alkyl aralkyl esters, trimellitic acid trialkyl esters, benzoic acid alkyl esters, dibenzoic acid esters of glycols, hydroxybenzoic acid esters, monoesters of saturated monocarboxylic acids, monoesters of hydroxymonocarboxylic acids, esters of unsaturated monocarboxylic acids, esters of saturated hydroxydicarboxylic acids, amides and esters of aromatic sulfonic acids, alkylsulfonic acid esters, glycerol esters, isosorbide esters, phosphoric acid esters, citric acid diesters, citric acid triesters, alkylpyrrolidone derivatives, 2,5-furandicarboxylic acid esters, 2,5-tetrahydrofurandicarboxylic acid esters, epoxidized vegetable oils, epoxidized fatty acid monoalkyl esters, 1,2-cyclohexanedicarboxylic acid dialkyl esters, 1,3-cyclohexanedicarboxylic acid dialkyl esters, 1,4-cyclohexanedicarboxylic acid dialkyl esters, polyesters of aliphatic and/or aromatic polycarboxylic acids with at least dihydric alcohols different from compounds (I), phthalic acid dialkyl esters different from compounds (II).

32. The plasticizer composition according to claim 24, where the content of compounds of the general formula (I) in the plasticizer composition is 10 to 99% by weight.

33. The plasticizer composition according to claim 24, where the content of compounds of the general formula (II) in the plasticizer composition is 1 to 90% by weight.

34. The plasticizer composition according to claim 24, where the weight ratio between compounds of the general formula (II) and compounds of the general formula (I) is in the range from 1:100 to 10:1.

35. A molding material comprising at least one polymer and a plasticizer composition as defined in claim 24.

36. The molding material according to claim 35, where the polymer is a thermoplastic polymer which is selected from
homopolymers or copolymers which comprise at least one monomer in polymerized-in form which is selected from the group consisting of C₂-C₁₀-monoolefins, 1,3-butadiene, 2-chloro-1,3-butadiene, vinyl alcohol and C₂-C₁₀-alkylesters thereof, vinyl chloride, vinylidene chloride, vinylidene fluoride, tetrafluoroethylene, glycidyl acrylate, glycidyl methacrylate, acrylates and methacrylates of C₁-C₁₀-alcohols, vinyl aromatics, acrylonitrile, methacrylonitrile, maleic anhydride and α,β-ethylenically unsaturated mono- and dicarboxylic acids,
homopolymers and copolymers of vinylacetates,
polyvinyl esters,
polycarbonates,
polyesters,
polyethers,
polyether ketones,
thermoplastic polyurethanes,
polysulfides,
polysulfones,
polyethersulfones,
cellulose alkyl esters,
and mixtures thereof.

37. The molding material according to claim 36, where the thermoplastic polymer is selected from polyvinyl chloride (PVC), polyvinylbutyral (PVB), homopolymers and copolymers of vinyl acetate, homopolymers and copolymers of styrene, polyacrylates, thermoplastic polyurethanes (TPU) or polysulfides.

38. The molding material according to claim 35, where the thermoplastic polymer is polyvinyl chloride (PVC).

39. The molding material according to claim 38, where the content of the plasticizer composition in the molding material is 5.0 to 300 phr.

40. The molding material according to claim 35, comprising at least one thermoplastic polymer different from polyvinyl chloride, where the content of the plasticizer composition in the molding material is 0.5 to 300 phr.

41. The molding material according to claim 35, where the polymer is an elastomer, preferably selected from natural rubbers, synthetic rubbers and mixtures thereof.

42. The molding material according to claim 41, where the content of the plasticizer composition in the molding material is 1.0 to 60 phr.

43. A process for producing moldings and films which comprises utilizing the molding material as defined in claim 35, wherein the molding or film is a housing of electrical devices, computer housings, tools, pipelines, cables, hoses, wire sheathings, window profiles, plastic profiles for conveyor belts, components for automobile construction, tires, furniture, foam for upholstery and mattresses, covers, sealants, composite films, self-adhesive films, laminating films, tarpaulins, roofing sheets, records, synthetic leather, packaging containers, adhesive tape films or coatings.

44. A molding or film comprising the plasticizer as claimed in claim 24, wherein the molding or film is a medicinal product, a hygiene product, a food packaging, a product for interiors, a toy and childcare articles, a sport and leisure product, clothing or fibers for fabric.
